(19) United States
(12) Patent Application Publication
(10) Pub. No.: US 2013/0067988 A1
(43) Pub. Date: Mar. 21, 2013

(54) Gas Measuring Apparatus

(71) Applicants: Toshiki Aoki, Tokyo (JP); Masayuki Inoue, Tokyo (JP)

(72) Inventors: Toshiki Aoki, Tokyo (JP); Masayuki Inoue, Tokyo (JP)

(73) Assignee: NIHON KOHDEN CORPORATION, Tokyo (JP)

(21) Appl. No.: 13/603,921

(22) Filed: Sep. 5, 2012

(30) Foreign Application Priority Data
Sep. 21, 2011 (JP) 2011-205831

(51) Int. Cl. G01N 7/00

(52) U.S. Cl. 73/23.21

(57) ABSTRACT

A gas measuring apparatus including: a measurement unit which obtains a measurement value with respect to a predetermined parameter of a gas to be measured; an altitude acquisition unit which acquires altitude information indicating an altitude of an installation location; an air pressure calculation unit which calculates an air pressure in the installation location, based on the altitude information; and a correction unit which corrects the measurement value based on a calculation value of the air pressure.

### BACKGROUND OF THE INVENTION

The present invention relates to a gas measuring apparatus for measuring a predetermined parameter of a gas to be measured, and more particularly to a gas measuring apparatus for measuring the concentration of a specific component in a respiratory gas of the subject.

Various apparatuses and methods of monitoring respiration of the patient (subject) who must be subjected to respiratory management in a clinical site or the like have been proposed. For example, known is a method which is called capnometry, and in which a temporal change of the partial pressure of carbon dioxide contained in the expired gas of the subject, i.e., the concentration of carbon dioxide in the expired gas is measured, thereby knowing the respiratory condition of the subject (for example, see Patent Reference 1).

(Patent Reference 1) JP-UM-A-2-131410

It is known that the measurement value in the above mentioned method is affected and changed by variations in the air pressure. In measurements in high and low altitude locations, changes are produced in measurement values indicating a certain specific condition. Therefore, a situation where the condition of the subject cannot be correctly known from an obtained measurement value may occur.

In the configuration disclosed in Patent Reference 1, an air pressure sensor is disposed to measure the air pressure in the measurement environment, and the measurement value of the gas concentration is corrected based on the measured air pressure. According to the configuration, a correct measurement value can be obtained. However, an air pressure measuring apparatus such as an air pressure sensor must be disposed in addition to a gas concentration measuring apparatus. This causes the apparatus size and the production cost to be increased.

### SUMMARY

The invention has been conducted in order to solve at least a part of the above-discussed problems. This invention provides a technique by which a correct gas measurement value according to the measurement environment can be obtained without additionally providing an air pressure measuring apparatus such as an air pressure sensor.

In order to solve at least a part of the above-discussed problems, a gas measuring apparatus according to the present invention includes: a measurement unit which obtains a measurement value with respect to a predetermined parameter of a gas to be measured; an altitude acquisition unit which acquires altitude information indicating an altitude of an installation location; an air pressure calculation unit which calculates an air pressure in the installation location, based on the altitude information; and a correction unit which corrects the measurement value based on a calculation value of the air pressure.

The gas measuring apparatus may further include a storage unit which stores a database containing: a plurality of geographical positions; and altitudes of the respective geographical positions, and the altitude acquisition unit acquires the altitude of a selected one of the geographical positions, as the altitude information.

The database may contain ambient temperature information of each of the geographical positions, and the air pressure calculation unit may calculate the air pressure based further on the ambient temperature information.

The altitude information may be acquired through a GPS device. The altitude acquisition unit may include a communication unit which acquires the altitude information acquired by the GPS device that is externally disposed, by means of communication.

The gas to be measured by the gas measuring apparatus is one of oxygen gas, carbon dioxide gas, anesthesia gas, and laughing gas.

### BRIEF DESCRIPTION OF THE DRAWINGS

FIG. 1 is a functional block diagram showing a gas measuring apparatus of a first embodiment of the invention.

FIG. 2 is a view schematically showing the configuration of a measurement unit in the gas measuring apparatus of FIG. 1.

FIG. 3 is a view showing the contents of a database in the gas measuring apparatus of FIG. 1.

FIG. 4 is a functional block diagram showing a gas measuring apparatus of a second embodiment of the invention.

FIG. 5 is a functional block diagram showing a gas measuring apparatus of a third embodiment of the invention.

FIG. 6 is a functional block diagram showing a gas measuring apparatus of a fourth embodiment of the invention.

### DETAILED DESCRIPTION OF EMBODIMENTS

Embodiments of the invention will be described in detail with reference to the accompanying drawings.

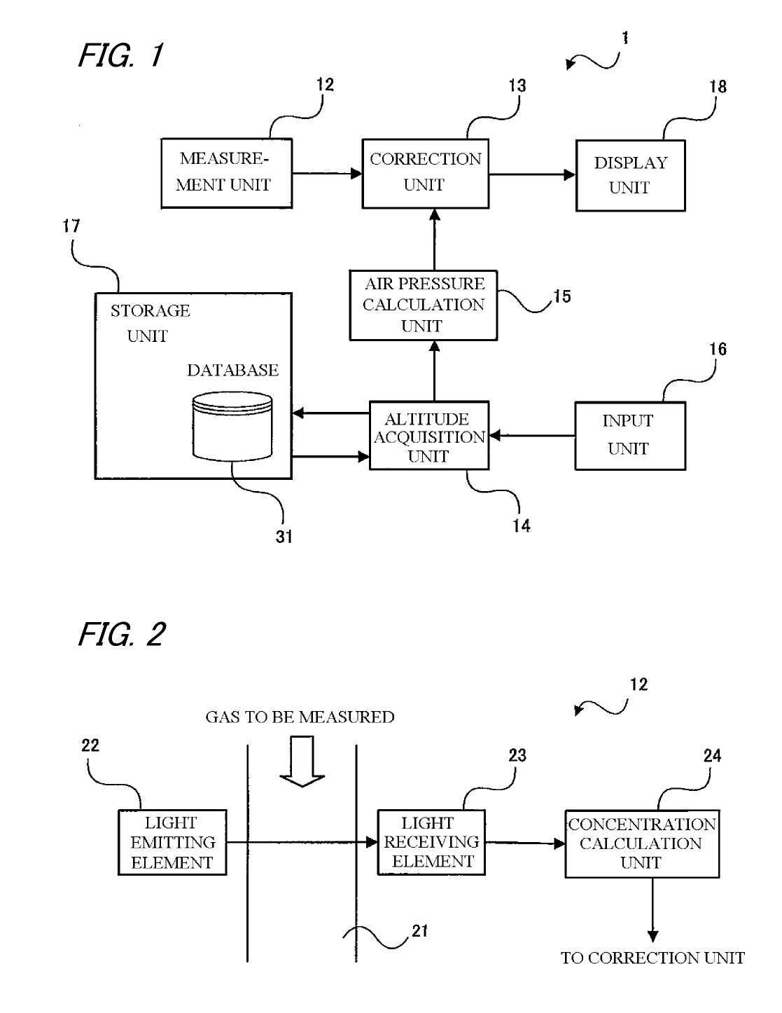

FIG. 1 shows a gas measuring apparatus 1 of a first embodiment of the invention. The gas measuring apparatus 1 is an apparatus which monitors the respiratory condition of the subject by, for example, measuring over time the concentration (a predetermined parameter of a gas to be measured) of carbon dioxide gas contained in the expired gas of the subject such as a patient who must be subjected to respiratory management.

As shown in FIG. 1, the gas measuring apparatus 1 includes a measurement unit 12, a correction unit 13, an altitude acquisition unit 14, an air pressure calculation unit 15, an input unit 16, a storage unit 17, and a display unit 18.

FIG. 2 schematically shows the configuration of the measurement unit 12. The measurement unit 12 includes an airway 21, a light emitting element 22, a light receiving element 23, and a concentration calculation unit 24.

The airway 21 is connected to a tracheal tube attached to the subject to allow its one end to communicate with the trachea of the subject, thereby enabling the respiratory gas of the subject to pass therethrough. The other end of the airway 21 is connected to an external apparatus such as an air bag or a ventilator through a respiratory circuit such as a tube. The airway 21 is not always required to be connected to a tracheal tube as far as the respiratory gas of the subject can pass through the airway. Namely, the invention can be applied also to the subject who does not use a tracheal tube (the subject who is not intubated).

When the measurement unit is attached to the subject, the light emitting element 22 and the light receiving element 23 are placed so as to be opposed to each other across the airway 21.

The light emitting element 22 is configured so as to emit light of a wavelength at which the absorbance by carbon dioxide gas is particularly high, among infrared light. The illustration of the configuration for supplying electric power to the light emitting element 22 is omitted.

The light receiving element 23 has a light receiving surface at a position where light that is emitted from the light emitting element 22 to pass through the airway 21 can be received. The light receiving element 23 outputs a signal having a voltage corresponding to the intensity of light which is received by the light receiving surface.

The higher the concentration of carbon dioxide gas existing in the airway 21, the higher the absorptance of light that is emitted from the light emitting element 22 to pass through the airway 21, and the lower the intensity of light which is received by the light receiving surface of the light receiving element 23. As the concentration of carbon dioxide gas contained in the expired gas of the subject is higher, therefore, the voltage of the signal output from the light receiving element 23 is lower.

The concentration calculation unit 24 calculates the concentration of carbon dioxide gas from the voltage value of the signal supplied from the light receiving element 23, to obtain a measurement value. The measurement value obtained by the concentration calculation unit 24 is output to the correction unit 13.

As the measurement value, alternatively, the partial pressure of carbon dioxide gas corresponding to the concentration of carbon dioxide gas may be obtained. A technique for obtaining a measurement value of the concentration or partial pressure of carbon dioxide gas from the output signal of the light receiving element 23 is known, and therefore its detailed description is omitted.

The measurement value is affected and changed by the air pressure and the ambient temperature. In order to use a value which correctly shows the condition of the subject, in the display to the measuring person, therefore, the measurement value must be corrected in accordance with the measurement environment to eliminate influences of the air pressure and the ambient temperature.

Therefore, the embodiment is configured so that the altitude acquisition unit 14 acquires altitude information indicating the altitude of the installation location of the gas measuring apparatus 1, the air pressure calculation unit 15 calculates the air pressure in the installation location based on the altitude information, and the correction unit 13 corrects the measurement value supplied from the concentration calculation unit 24 of the measurement unit 12, based on the calculation value of the air pressure.

The input unit 16 is communicably connected to the altitude acquisition unit 14, and used for inputting by the user geographical position information indicating the installation location of the gas measuring apparatus 1. Examples of geographical position information are an address, a zip code, a telephone number, the latitude and longitude, and the like.

The storage unit 17 is communicably connected to the altitude acquisition unit 14, and configured so as to receive geographical position information which is input by the user through the input unit 16, from the altitude acquisition unit 14.

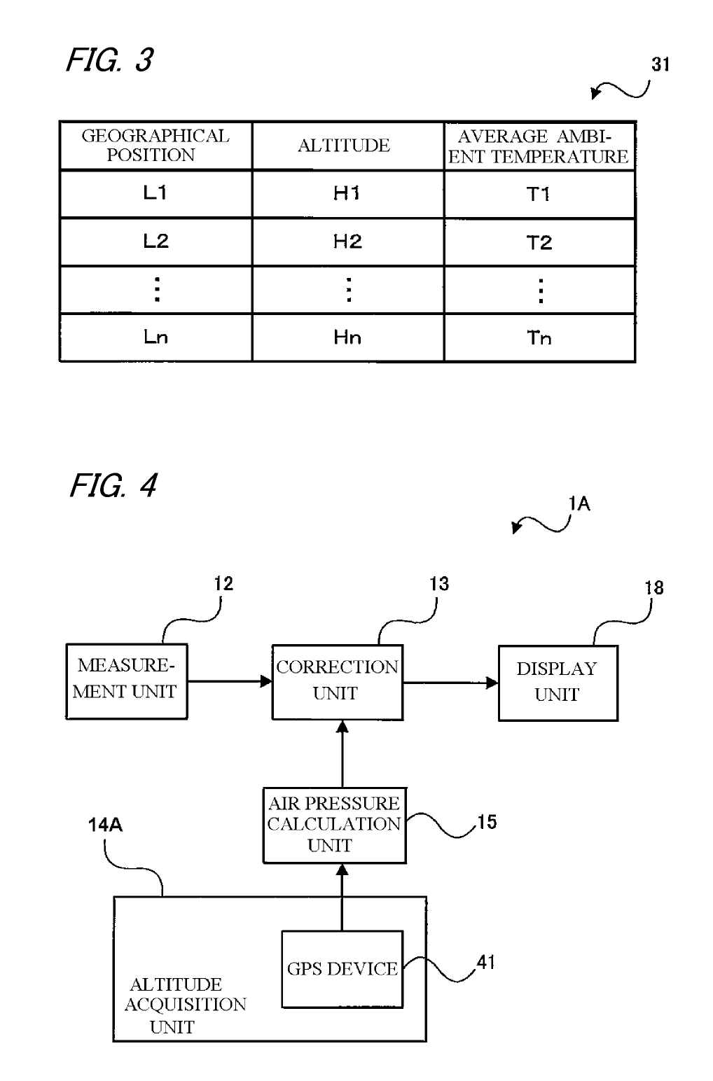

The storage unit 17 includes a database 31. As shown in FIG. 3, the database 31 previously stores correspondence relationships between a plurality of geographical positions, and the altitudes and average ambient temperatures of the geographical positions.

When geographical position information is supplied from the altitude acquisition unit 14 to the storage unit 17, a control unit which is not shown searches the database 31, and selects the geographical position corresponding to the geographical position information. The control unit causes the altitude and average ambient temperatures corresponding to the selected geographical position, to be output as altitude information and ambient temperature information, from the storage unit 17 to the altitude acquisition unit 14.

The ambient temperature information may be automatically or manually changed to an average ambient temperature corresponding to the time of use of the gas measuring apparatus 1. In this case, preferably, a plurality of average ambient temperatures are correlated with the geographical positions in the database 31.

When the user inputs an address or “C, B City, A Prefecture” through the input unit 16, for example, geographical position information indicating the address is supplied to the storage unit 17 via the altitude acquisition unit 14. Then, the control unit searches the database 31. When the geographical position corresponding to “C, B City, A Prefecture” is selected as L2 in FIG. 3, altitude information H2 (for example, an altitude of 1,800 m) and ambient temperature information T2 (for example, 18° C.) corresponding to L2 are supplied from the storage unit 17 to the altitude acquisition unit 14.

The altitude acquisition unit 14 outputs the altitude information and ambient temperature information obtained from the storage unit 17, to the air pressure calculation unit 15. The air pressure calculation unit 15 calculates the air pressure P [hPa] in the installation location of the gas measuring apparatus 1 in accordance with the following expression.

$$\begin{matrix}[ Exp . 1 ] & \\ P = {{P}_{0} ( 1 - \frac{0.0065 h}{{T}_{0} + 273.15} )}^{5.257} \\ {T}_{0} = T + 0.0065 h & ( 1 )\end{matrix}$$

In the expression, Po indicates the air pressure (1,013.0 [hPa]) at the altitude of 0 m, h [m] indicates the altitude of the present location, T indicates the ambient temperature [° C.] in the present location, and To indicates the ambient temperature [° C.] at the altitude of 0 m. The air pressure calculation unit 15 calculates P by substituting the altitude information and ambient temperature information which are supplied from the altitude acquisition unit 14, respectively as h and T above into the above expression.

Usually, the temperature of the room where the gas measuring apparatus 1 is disposed is controlled so as to have a constant value. In the case where it is contemplated that the ambient temperature exerts less influence on the measurement value as compared with the air pressure, T in the expression above may be set as a constant or the room temperature (for example, 25° C.). In this case, data of the average ambient temperature in the database 31 may be omitted.

The value of the air pressure in the installation location of the gas measuring apparatus 1 which is calculated by the air pressure calculation unit 15 is supplied to the correction unit 13. The correction unit 13 corrects the measurement value of the concentration (or partial pressure) of carbon dioxide gas which is supplied from the concentration calculation unit 24 of the measurement unit 12, based on the calculation value of the air pressure supplied from the air pressure calculation unit 15. There are various methods of correcting a measurement value of the concentration (or partial pressure) based on the air pressure, depending on the gas to be measured and the measuring method (the principle and the structure). Therefore, a technique which has been conventionally employed may be used, and its detailed description is omitted.

The correction unit 13 outputs the corrected measurement value of the concentration (or partial pressure) of carbon dioxide gas to the display unit 18. In the display unit 18, the corrected measurement value is displayed in such a manner that the measuring person can view the value. At this time, the corrected measurement value may be converted to a value of a normalized displaying method such as STPD (Standard Temperature, Pressure and Dry), BTPS (Body Temperature and Pressure, Saturated with water vapor), or ATPS (Ambient Temperature and Pressure, Saturated with water vapor), and the converted value may be displayed.

As described above, when the user inputs only geographical position information such as the address or zip code of the installation location in the process of installing the gas measuring apparatus 1, at least the altitude information of the installation location is acquired from the previously stored database 31. The measurement value of the concentration or partial pressure of carbon dioxide gas is corrected based on the altitude information. Therefore, the condition of the subject can be accurately known from the obtained correct measurement value without additionally providing a measuring apparatus such as an air pressure sensor.

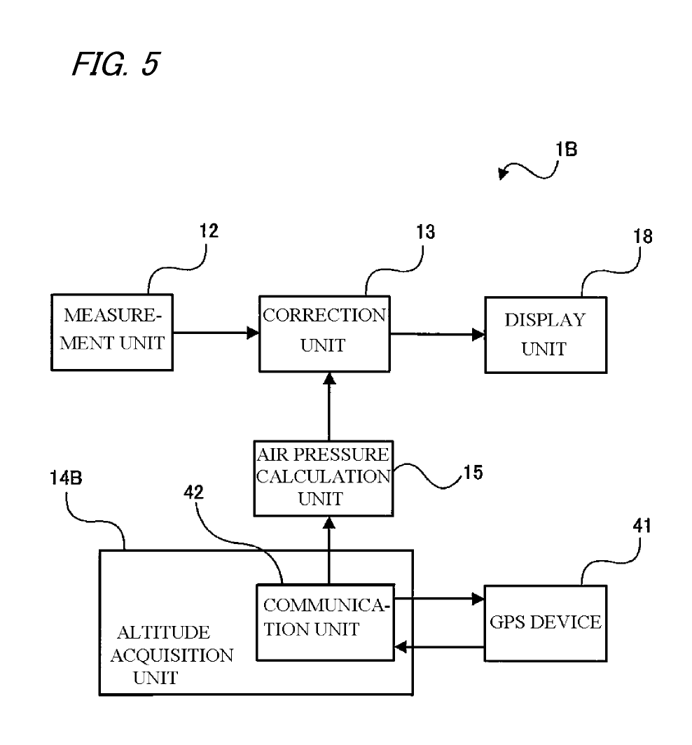

Next, a gas measuring apparatus 1A of a second embodiment of the invention will be described with reference to FIG. 4. The components which are substantially identical with or similar to those of the first embodiment are denoted by the same reference numerals, and duplicated description is omitted.

The gas measuring apparatus 1A of the embodiment is different from the gas measuring apparatus 1 of the first embodiment in that an altitude acquisition unit 14A includes a GPS device 41.

In installation of the gas measuring apparatus 1A, when the user activates an altitude acquisition process, the GPS device 41 of the altitude acquisition unit 14A receives radio waves from GPS satellites. The GPS device 41 identifies the geographical position (the latitude, the longitude, and the altitude) of the gas measuring apparatus 1A from the received radio waves. The method of identifying the present location from radio waves received from GPS satellites is known, and hence its detailed description is omitted.

The altitude acquisition unit 14A outputs the value of the altitude of the installation location of the gas measuring apparatus 1A which is identified through the GPS device 41, as the altitude information to the air pressure calculation unit 15. The air pressure calculation unit 15 calculates the value of the air pressure in the installation location by using Expression (1) in a similar manner with the first embodiment. Here, the value of the ambient temperature T in the present location is set to the constant (the room temperature).

The correction unit 13 corrects the measurement value of the concentration (or partial pressure) of carbon dioxide gas supplied from the concentration calculation unit 24 of the measurement unit 12, based on the calculation value of the air pressure supplied from the air pressure calculation unit 15.

According to the configuration of the embodiment, the altitude acquisition unit 14A automatically acquires altitude information through the GPS device 41, and the measurement value is corrected based on the altitude information. Therefore, the condition of the subject can be accurately known from the obtained correct measurement value without additionally providing a measuring apparatus such as an air pressure sensor.

Unlike the first embodiment, it is not necessary to previously prepare the database 31 showing correspondence relationships between geographical position information and altitude information. Also the input of geographical position information by the user can be omitted. Therefore, the acquisition of the altitude information and the correction of the measurement value can be more easily executed.

Next, a gas measuring apparatus 1B of a third embodiment of the invention will be described with reference to FIG. 5. The components which are substantially identical with or similar to those of the above-described embodiments are denoted by the same reference numerals, and duplicated description is omitted.

The gas measuring apparatus 1B of the embodiment is different from the gas measuring apparatus 1A of the second embodiment in that an altitude acquisition unit 14B includes a communication unit 42 which is communicable with the GPS device 41 that is externally disposed.

In installation of the gas measuring apparatus 1B, when the user activates the altitude acquisition process, the communication unit 42 of the altitude acquisition unit 14B instructs the GPS device 41 that is disposed outside the gas measuring apparatus 1B, to acquire geographical position information.

The GPS device 41 identifies the geographical position (the latitude, the longitude, and the altitude) of the gas measuring apparatus 1B based on the radio waves received from GPS satellites. The communication unit 42 receives information of the identified geographical position of the gas measuring apparatus 1B, from the GPS device 41.

The altitude acquisition unit 14B outputs the value of the altitude of the installation location of the gas measuring apparatus 1B which is identified through the GPS device 41, as the altitude information to the air pressure calculation unit 15. The air pressure calculation unit 15 calculates the value of the air pressure in the installation location by using Expression (1) in a similar manner with the first embodiment. Here, the value of the ambient temperature T in the present location is set to the constant (the room temperature).

The correction unit 13 corrects the measurement value of the concentration (or partial pressure) of carbon dioxide gas supplied from the concentration calculation unit 24 of the measurement unit 12, based on the calculation value of the air pressure supplied from the air pressure calculation unit 15.

According to the configuration of the embodiment, the altitude acquisition unit 14B automatically acquires altitude information through the external GPS device 41, and the measurement value is corrected based on the altitude information. Therefore, the condition of the subject can be accurately known from the obtained correct measurement value without additionally providing a measuring apparatus such as an air pressure sensor.

Unlike the first embodiment, it is not necessary to previously prepare the database 31 showing correspondence relationships between geographical position information and altitude information. Also the input of geographical position information by the user can be omitted. Therefore, the acquisition of the altitude information and the correction of the measurement value can be more easily executed.

According to the configuration of the embodiment, a plurality of gas measuring apparatuses 1B each including the communication unit 42 can share the single GPS device which is externally disposed. Each of the measuring apparatuses is not required to incorporate the GPS device 41, and therefore the configuration contributes to reduction of production cost.

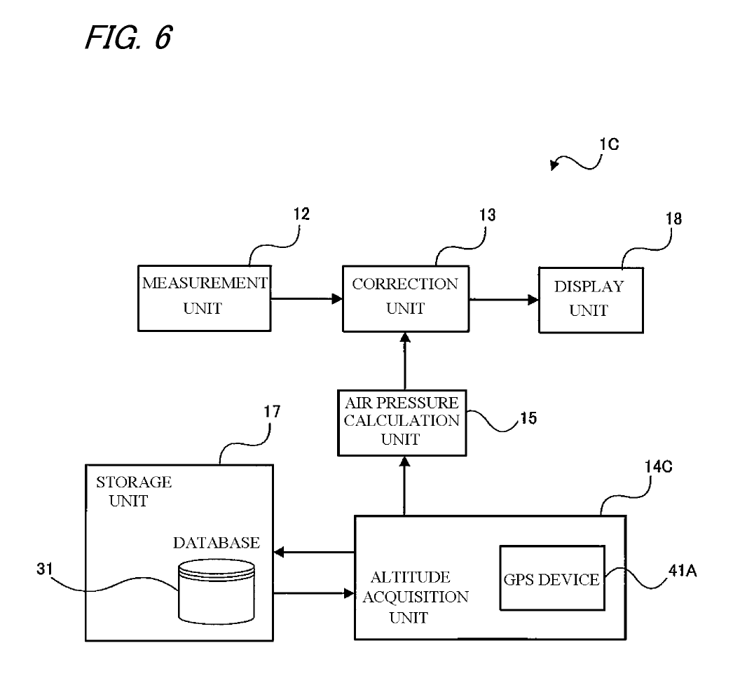

Next, a gas measuring apparatus 1C of a fourth embodiment of the invention will be described with reference to FIG. 6. The components which are substantially identical with or similar to those of the above-described embodiments are denoted by the same reference numerals, and duplicated description is omitted.

The gas measuring apparatus 1C of the embodiment is different from the gas measuring apparatus 1 of the first embodiment in that an altitude acquisition unit 14C including a GPS device 41A is communicable with the storage unit 17 including the database 31.

In installation of the gas measuring apparatus 1C, when the user activates the altitude acquisition process, the GPS device 41A of the altitude acquisition unit 14C receives radio waves from GPS satellites. The GPS device 41A identifies the geographical position (the latitude and longitude) of the gas measuring apparatus 1C from the received radio waves.

The altitude acquisition unit 14C outputs the values of the latitude and longitude of the installation location of the gas measuring apparatus 1C which are identified through the GPS device 41A, as the geographical position information to the storage unit 17.

When the geographical position information is supplied from the altitude acquisition unit 14C to the storage unit 17, the control unit which is not shown searches the database 31, and selects the geographical position corresponding to the geographical position information. The control unit causes the altitude and average ambient temperatures corresponding to the selected geographical position, to be output as altitude information and ambient temperature information, from the storage unit 17 to the altitude acquisition unit 14C.

When a geographical position corresponding to values of X degrees latitude and Y degrees longitude is selected as Ln in FIG. 3, for example, altitude information Hn (for example, an altitude of 900 m) and ambient temperature information Tn (for example, 20° C.) corresponding to Ln are supplied from the storage unit 17 to the altitude acquisition unit 14C.

The altitude acquisition unit 14C outputs the altitude information and ambient temperature information which are acquired from the storage unit 17, to the air pressure calculation unit 15. The air pressure calculation unit 15 calculates the value of the air pressure in the installation location by using Expression (1) in a similar manner with the first embodiment. Here, the value of the ambient temperature T in the present location in Expression (1) is set to the constant (the room temperature), and data of average ambient temperatures in the database 31 may be omitted.

The correction unit 13 corrects the measurement value of the concentration (or partial pressure) of carbon dioxide gas supplied from the concentration calculation unit 24 of the measurement unit 12, based on the calculation value of the air pressure supplied from the air pressure calculation unit 15.

According to the configuration of the embodiment, the altitude acquisition unit 14C automatically acquires geographical position information through the GPS device 41A, at least altitude information of the installation location is acquired from the database 31 which is previously stored, and the measurement value of the concentration or partial pressure of carbon dioxide gas is corrected based on the altitude information. Therefore, the condition of the subject can be accurately known from the obtained correct measurement value without additionally providing a measuring apparatus such as an air pressure sensor.

Also the input of geographical position information by the user can be omitted. Therefore, the acquisition of the altitude information and the correction of the measurement value can be more easily executed.

Furthermore, it is necessary only to acquire at least two-dimensional information of the latitude and the longitude. Therefore, the GPS device 41A can be configured more economically than the GPS device 41 which acquires three-dimensional information.

As in the gas measuring apparatus 1B of the third embodiment shown in FIG. 5, the altitude acquisition unit 14C may be replaced with the altitude acquisition unit 14B including the communication unit 42. In this case, the communication unit 42 acquires geographical position information of the installation location of the gas measuring apparatus 1C from the GPS device 41A which is externally disposed, and the database 31 is searched based on the geographical position information.

The embodiments have been described in order to facilitate understanding of the invention, and are not intended to limit the invention. It is a matter of course that the invention may be changed or improved without departing the spirit thereof, and includes equivalents of such changes and modifications.

In addition to above-described carbon dioxide gas, oxygen gas, anesthesia gas, laughing gas, and the like can be used as the gas to be measured. The predetermined parameter is not limited to the above-described gas concentration or gas partial pressure. As far as a parameter is affected by the air pressure, a measurement value of the parameter can be corrected by the technique of the invention. In the case where a parameter other than a gas concentration or a gas partial pressure is to be measured, the measurement unit 12 may be adequately replaced with a known configuration for measuring the parameter.

In the above-described embodiments, the measurement unit 12 includes the airway 21, and at least the light emitting element 22 and the light receiving element 23 are separated from the apparatus main unit. The concentration calculation unit 24 may constitute together with the light emitting element 22 and the light receiving element 23, a sensor unit, or may be disposed in the apparatus main unit, together with the correction unit 13, the altitude acquisition unit 14, and the air pressure calculation unit 15. A configuration may be employed in which at least one of the correction unit 13, the altitude acquisition unit 14, and the air pressure calculation unit 15 is disposed in the sensor unit.

In place of the above-described configuration (so called main stream system), a configuration (so called side stream system) may be employed in which the measurement unit 12 is incorporated in the apparatus main unit, and the expired gas of the subject is introduced into the measurement unit 12 through a tube branching from the respiratory circuit attached to the subject.

The input unit 16 is not required to be configured as a part of the apparatus. When a monitoring apparatus or a general-purpose computer is communicably connected to the altitude acquisition unit 14, for example, geographical position information can be input through a man-machine interface provided in the monitoring apparatus or the general-purpose computer.

The display unit 18 is not required to be configured as a part of the apparatus. When an adequate monitoring apparatus is communicably connected to the correction unit 13, the corrected measurement value output from the correction unit 13 is used in the display to the measuring person. Preferably, the monitoring apparatus has a function of conversion to the above-described normalized displaying method. In the case where the correction unit has the conversion function, a monitoring apparatus having only a display function can be used.

According to the configuration of the invention, the air pressure which is a relatively large factor of variation of the gas measurement value is calculated based on the altitude of the installation location of the gas measuring apparatus. Therefore, the condition of the subject can be accurately known from the obtained correct measurement value without additionally providing a measuring apparatus such as an air pressure sensor.

When the database of a plurality of geographical positions and the altitudes of the respective geographical positions is previously stored, altitude information can be easily acquired by selecting one of the geographical positions.

In the configuration where the database contains the ambient temperature information for each of the geographical positions, the air pressure in the installation location of the gas measuring apparatus can be calculated more correctly. When the ambient temperature information is that corresponding to the time of using the gas measuring apparatus, the correctness of the calculation of the air pressure can be further improved.

In the configuration where the GPS device acquires the altitude information, the user is not required to select one of the geographical positions, and the acquisition of the altitude information and the correction of the measurement value can be executed easily and automatically. When the GPS device can acquire altitude information, the database can be omitted.

In the configuration where the GPS device is externally disposed, and the altitude acquisition unit includes a communication unit which acquires the altitude information obtained by the GPS device, by means of communication, a single GPS device can be shared by a plurality of gas measuring apparatuses.

What is claimed is:

1. A gas measuring apparatus including:
a measurement unit which obtains a measurement value with respect to a predetermined parameter of a gas to be measured;
an altitude acquisition unit which acquires altitude information indicating an altitude of an installation location;
an air pressure calculation unit which calculates an air pressure in the installation location, based on the altitude information; and
a correction unit which corrects the measurement value based on a calculation value of the air pressure.

2. A gas measuring apparatus according to claim 1, wherein the apparatus further includes a storage unit which stores a database containing: a plurality of geographical positions; and altitudes of the respective geographical positions, and
the altitude acquisition unit acquires the altitude of a selected one of the geographical positions, as the altitude information.

3. A gas measuring apparatus according to claim 2, wherein the database contains ambient temperature information of each of the geographical positions, and
the air pressure calculation unit calculates the air pressure based further on the ambient temperature information.

4. A gas measuring apparatus according to claim 1, wherein the altitude information is acquired through a GPS device.

5. A gas measuring apparatus according to claim 4, wherein the altitude acquisition unit includes the GPS device.

6. A gas measuring apparatus according to claim 4, wherein the altitude acquisition unit includes a communication unit which acquires the altitude information acquired by the GPS device that is externally disposed, by means of communication.

7. A gas measuring apparatus according to claim 2, wherein
the altitude acquisition unit includes a GPS device, and communicable with the storage unit,
the altitude acquisition unit outputs values indicative of the installation location acquired through the GPS device, to the storage unit, and
the storage unit outputs the altitude information corresponding to the installation location, to the altitude acquisition unit.

8. A gas measuring apparatus according to claim 1, wherein the gas to be measured is one of oxygen gas, carbon dioxide gas, anesthesia gas, and laughing gas.
